(19) United States
(12) Patent Application Publication
(10) Pub. No.: US 2024/0269886 A1
(43) Pub. Date: Aug. 15, 2024

(54) METHOD AND PRODUCTION SYSTEM FOR PRODUCING A CONCRETE COMPONENT, AND CONCRETE COMPONENT

(71) Applicant: AEDITIVE GMBH, Norderstedt (DE)

(72) Inventors: Roman GERBERS, Hamburg (DE); Niklas NOLTE, Hamburg (DE); Hendrik LINDEMANN, Hamburg (DE)

(21) Appl. No.: 18/568,460

(22) PCT Filed: Jun. 22, 2022
(86) PCT No.: PCT/DE2022/100459

§ 371 Date: Dec. 8, 2023

(30) Foreign Application Priority Data
Jun. 23, 2021 (DE) 10 2021 116 194.0

(51) Int. Cl. B28B 1/00; B32B 13/04; B33Y 10/00; B33Y 30/00; B33Y 80/00; E04G 21/04

(52) U.S. Cl. CPC B28B 1/008; B28B 1/001; B32B 13/04; B33Y 10/00; B33Y 30/00; B33Y 80/00; E04G 21/04

(57) ABSTRACT

The invention relates to a method of producing a structural concrete component (100, 200), comprising the steps of: Producing a first component section (126, 226) and a second component section (132, 232) with concrete, wherein the first component section (126, 226) and the second component section (132, 232) are produced with a free-forming method, and wherein the concrete is provided such that a first setting time of the concrete of the first component section (126, 226) and a second setting time of the second component section (132, 232) are different.

The invention relates to a method and a production system for producing a structural concrete component and to a structural concrete component.

Methods for producing structural concrete components are known in principle. For producing structural concrete components with a free-forming manufacturing process, for example a shotcrete process or an extrusion process, different concrete admixtures are usually required. For a controlled build-up of structural concrete components using a free-forming method, accelerating agents, also known as accelerators or BE for short, are usually required.

A high accelerator content in the concrete to be processed enables high application rates, since in particular a high number of layers can be arranged one above the other without the lower layers being significantly deformed due to gravity. A disadvantage of using accelerators is often that they can lead to a lack of bond between individual layers. In the case of structural concrete components which have an integrated reinforcement, the concrete usually also has to be placed behind the reinforcement, so that a high accelerator content can lead to the disadvantage of a splash shadow and a poor bond between the concrete and the reinforcement. In addition, a high accelerator content reduces the smoothness of a structural concrete component.

Due to the high costs and process-related disadvantages of accelerators, it is an objective to use as few accelerators as possible.

It is therefore an object of the invention to provide a method and a production system for producing a structural concrete component, as well as a structural concrete component, which reduce or eliminate one or more of the disadvantages mentioned. In particular, it is an object of the invention to provide a solution that reduces the required accelerator content in the concrete used for a structural concrete component.

This task is solved with a method and a production system as well as a structural concrete component according to the features of the independent patent claims. Further advantageous embodiments of these aspects are indicated in the respective dependent patent claims. The features listed individually in the patent claims and the description can be combined with one another in any technologically useful manner, with further embodiments of the invention being indicated.

According to a first aspect, the task is solved by a method for producing a structural concrete component, comprising the steps of: producing a first component section and a second component section with concrete which preferably comprises an accelerator means, wherein the first component section and the second component section are produced with a free-forming method, in particular a shotcrete method and/or an extrusion method, wherein the concrete is provided such that a first setting time of the concrete of the first component section and a second setting time of the second component section are different.

The invention is based on the realization that the producing of structural concrete components with component section-specific setting times is made possible at a lower cost and with a higher quality. For example, a reduced accelerator content improves the bonding of individual concrete layers arranged one on top of the other. In addition, the smoothness of the surfaces is improved. Furthermore, a bond between the applied concrete and an applied reinforcement is optimized. In addition, the lower the accelerator content is selected, the lower the risk of air entrapment. Furthermore, the inventors have found that the productivity of the manufacturing process is increased, since the delivery rate can be increased at low accelerator percentages.

The first component section and the second component section are produced with concrete which preferably comprises an accelerator agent. The accelerating agent is in particular mixed with the other constituents of the concrete. Concrete is understood to mean, in particular, a composite material. In particular, the concrete is a building material which is mixed as a dispersion with the addition of liquid from a binder and aggregates. The binder is preferably cement and/or the aggregate is an aggregate. The first component section and/or the second component section are preferably configured with a concrete application direction which is angled with respect to the planar extent of the first component section and/or the second component section, wherein preferably the concrete application direction is oriented at an angle with respect to a plane orthogonal to the planar extent of the first component section and/or the second component section.

The first component section and the second component section are preferably predetermined, in particular based on their geometry. The first component section preferably has a first geometry and the second component section has a second geometry, wherein these geometries are different from each other. For example, the first geometry may be a wall and the second geometry may be a filler. The generation of the first component section and the second component section is preferably performed on a steel pallet. The first geometry is preferably configured with the angled concrete application direction. The second geometry is preferably configured with a tumbling concrete application direction.

It is preferred that before the first structural component section and the second structural component section are generated, a base section is first generated, which is preferably to be understood as the lowest layer of the structural concrete component. This base section can be produced, for example, on a base, in particular the steel pallet mentioned in the preceding. A concrete application direction, in particular a concrete discharge direction of a spray nozzle, is preferably aligned essentially orthogonally to the base section for generating the base section.

In particular, the accelerating agent is to be understood as a concrete admixture that accelerates the setting and/or hardening of the concrete. For example, the accelerating means may be a setting accelerator, a hardening accelerator, and/or a shotcrete accelerator.

The first component section and the second component section are produced by a free-forming method. A free-forming method is to be understood in particular as a formwork-free method. The free-forming method is in particular a shotcrete method and/or an extrusion method, in particular a concrete extrusion method.

The concrete for producing the first component section and the second component section is provided such that the first setting time of the concrete of the first component section and the second setting time of the second component section are different. The different setting times can be enabled, for example, with a different accelerator proportion, as will be explained in more detail below. As a result, the concrete of one component section has less accelerator than the other.

For example, the setting time of an applied concrete describes the time after application until the transition from the plastic to the solid state. The setting time can also be understood as the time until the onset of setting. Furthermore, a setting time may be understood as the time required for the concrete to set, for example until the end of setting and/or beyond that until early strength is formed.

A preferred embodiment of the method is characterized in that the concrete is provided with an accelerator, and the concrete for the first component section has a first accelerator component and the concrete for the second component section has a second accelerator component different from the first accelerator component.

The accelerator may be added to the staging mix, for example. Accordingly, the concrete with the accelerator is already provided as an initial mix from the concrete mixer. Alternatively or additionally, the accelerator can be added at a shotcrete nozzle.

The accelerator proportion is, for example, the proportion of the accelerator in the concrete. The accelerator proportion may be expressed, for example, as a percentage. In addition, the accelerator proportion can be specified as a weight proportion, for example kilogram accelerator proportion per ton of concrete.

Further, the accelerator proportion may be specified on a volume basis, for example liter accelerator per cubic meter of concrete. If one of the component sections is produced with a higher accelerator content than the other component section, that component section will set faster and have a shorter setting time. The accelerator proportion can also be zero. The first and/or second accelerator portion can also each be a region.

The accelerator proportion can be gradually adjusted along at least one component direction of the structural concrete component. For example, the accelerator fraction may change steadily from the first accelerator fraction to the second accelerator fraction, for example linearly. It is particularly preferred that the method comprises the step of: Creating a third component section arranged between the first component section and the second component section with concrete, wherein a third accelerator portion of the concrete of the third component section changes along a component direction, in particular along a component direction directed from the first component section to the second component section.

In a further preferred embodiment, it is provided that the concrete for the first component section is provided with a first accelerator means and the concrete for the second component section is provided with a second accelerator means, wherein the first accelerator means effects the first setting time and the second accelerator means effects the second setting time.

Alternatively or in addition to different accelerator proportions, different accelerator means can also be applied, which influence the setting time in different ways. The first accelerator means is preferably different from the second accelerator means.

A further preferred embodiment of the method is characterized in that the first component section is generated such that it laterally encloses a filling space, the second component section is generated such that it fills the filling space, and the first component section is generated temporally before the second component section. It is preferred that the first setting time is less than the second setting time.

Preferably, the first accelerator portion is higher than the second accelerator portion.

The first component section is preferably configured as one, two or more side walls. These side walls preferably enclose the filling space. For example, the first component section may have four side walls arranged such that they form a substantially rectangular cross-section. The first component section is rapidly built up with the low first setting time. In addition, the construction of the component section enclosing the filling space with a high accelerator ratio or a low first setting time is particularly advantageous, since the concrete of the first component section does not deliquesce. The first component section can thus be produced with particular accuracy of shape.

The filling space configured by the first component section is then filled with concrete, whereby this filling constitutes the second component section. The second component section has a higher second setting time. Since the concrete of the second component section is held in position by the first component section, there is no need here to provide a high accelerator content or a low setting time. The second component section can be produced, for example, with a concrete without accelerator.

The second component section is characterized in such a way that it has a good bond between the individual layers. In addition, it has good strength. The combination of such a first component section for the fast and safe creation of a filling space and the subsequent filling of the filling space with a concrete with little or no accelerator provides a particularly high-quality component in a short time.

A further preferred embodiment of the method comprises the step of: arranging a reinforcement unit, in particular a reinforcement cage, wherein the first component section is generated at least in sections on a first side and the second component section is generated on a second side of the reinforcement unit opposite the first side.

The reinforcement unit comprises at least one reinforcement element, preferably two or more reinforcement elements. A reinforcement unit configured as a reinforcement cage preferably comprises a plurality of reinforcement elements. A reinforcement element is preferably a straight and/or bent steel element. The reinforcement unit is preferably arranged on the solidified base section. Thus, precise positioning of the reinforcement unit is made possible. Alternatively, the reinforcement unit can be positioned on a base with spacers and then the base section is created under the reinforcement unit. It is particularly preferred that the base section is generated with a small amount of accelerator.

A further preferred embodiment of the method is characterized in that the reinforcement unit has lateral reinforcement sections which are aligned vertically, in particular during the producing of the structural concrete component, and form a reinforcement space, the first component section enclosing the lateral reinforcement sections of the reinforcement unit, the second component section being produced within the reinforcement space, in particular at least partially filling the reinforcement space, and the first setting time being shorter than the second setting time.

The lateral reinforcement sections preferably have a planar extension which is oriented vertically. An area orthogonal to said planar extent is oriented substantially horizontally.

The first component section encloses the lateral reinforcement sections of the reinforcement unit. The lateral reinforcement sections are thus arranged at least partially within the first component section. Thus, the filling space can be produced in an advantageous manner.

According to a further preferred embodiment of the method, the method comprises the step of: creating a support structure within the filling space and/or reinforcement space, in particular of concrete, which is arranged and configured to reduce a hydrostatic pressure on the first component section, wherein preferably the support structure forms two or more support spaces for receiving concrete of the second component section.

In large volume structural concrete components, the filling space configured by the first structural component section has a large volume. When this filling space is filled with the concrete for the second component section, the first component section, in particular the side walls of the first component section, is applied with a high hydrostatic pressure. The larger the structural concrete component is configured, the greater this hydrostatic pressure can be. In order to reduce the load on the first component section and/or to reduce the hydrostatic pressure on the first component section, the support structure is created.

Preferably, the support structure generates two or more support spaces. The support spaces are preferably fluidically separated from each other. The two or more support spaces reduce the hydrostatic pressure on the first component section. As a result, a better structural concrete component can be produced, in particular having a higher concrete quality and a higher dimensional stability.

Another preferred embodiment of the method comprises the step of: producing a cover layer coupled to the first component section and/or the second component section, wherein the cover layer is produced with a concrete having a third setting time, wherein the third setting time is greater than the first setting time and/or second setting time. The top layer may, for example, be materially bonded to the first component section and/or the second component section, preferably materially bonded. Preferably, the cover layer is configured with a concrete application direction that is oriented substantially orthogonal to a planar formation of the cover layer.

It is furthermore preferred that a further concrete layer is arranged on the outwardly facing sides of the structural concrete component, this concrete layer having a high setting time, in particular a setting time which is higher than the first, second and/or third setting time, in order to improve the smoothness of the structural concrete component.

In a further preferred embodiment of the method, it is provided that a retarder is applied to generate the first component section, second component section and/or the cover layer.

According to a further aspect, the above-mentioned task is solved by a production system for producing a structural concrete component, in particular for carrying out a method according to one of the embodiments described in the foregoing, comprising an application unit for producing a first component section and a second component section with concrete, which comprises an accelerator means, and a control device which is arranged and configured to control a mixing of the concrete with the accelerator means such that a first setting time of the concrete of the first component section and a second setting time of the concrete of the second component section are different.

The application unit is arranged and configured to produce the first component section and the second component section with concrete. For example, the application unit may be configured to spray and/or extrude concrete.

Preferably, the control device is arranged and configured to enable component section-specific setting of the setting time. It is further preferred that the control device is arranged and configured to generate a support structure and/or a top layer with the application unit.

It is further preferred that the manufacturing system comprises a mixing unit and/or a supply unit coupled to the application unit and/or the control device. The mixing unit is preferably arranged and configured to mix the concrete with the accelerating agent. The provision unit is preferably arranged to provide the concrete and/or the accelerating agent.

According to a further aspect, the above-mentioned task is solved by a structural concrete component comprising a first structural component section and a second structural component section, wherein the concrete of the first structural component section has a first setting time and the concrete of the second structural component section has a second setting time, wherein the first setting time and the second setting time are different.

The structural concrete component may be, for example, a bridge cap, a retaining wall, in particular with natural stones, a purlin, a staircase or a balcony. Further, the structural concrete component may be a bridge or tunnel segment, an infrastructure element, a wall or floor element, a column, a beam, or a foundation.

Preferably, the first structural member section and/or the second structural member section are adjacent to a base section that acts as a bottom surface during producing.

A preferred further formation of the structural concrete component is characterized in that the concrete of the first structural component section has a first accelerator portion and the concrete of the second structural component section has a second accelerator portion different from the first accelerator portion. As a rule, the higher the accelerator proportion, the shorter the setting time. The accelerator proportion can also be zero.

In a preferred embodiment of the structural concrete component, the latter comprises a reinforcement unit, in particular a reinforcement cage, the first component section being arranged at least in sections on a first side and the second component section being arranged on a second side of the reinforcement unit opposite the first side.

In a further preferred embodiment of the structural concrete component, it is provided that the reinforcement unit has lateral reinforcement sections which are aligned vertically, in particular during producing of the structural concrete component, and form a reinforcement space, the first component section encloses the lateral reinforcement sections of the reinforcement unit, the second component section is arranged within the reinforcement space, in particular at least partially fills the reinforcement space, and the first setting time is shorter than the second setting time.

It is further preferred that the structural concrete component comprises a support structure within the filling space, in particular made of concrete or comprising concrete, arranged and configured to reduce a hydrostatic pressure on the first component portion. It is preferred that the support structure comprises two or more support spaces within which concrete of the second component section is disposed.

Preferably, the support structure comprises vertical and horizontal support members that include an angle with each other. For example, these may include a 90° angle with each other. The hydrostatic pressure is caused during the producing of the structural concrete component, in particular by the concrete of the second structural component section.

Another preferred embodiment of the structural concrete component comprises a cover layer coupled to the first structural component section and/or the second structural component section, wherein the cover layer comprises or consists of a concrete having a third setting time, wherein the third setting time is greater than the first setting time and/or second setting time.

For further advantages, embodiments and details of embodiments of the further aspects and their possible further embodiments, reference is also made to the description given previously regarding the corresponding features and further embodiments of the method for producing a structural concrete component.

Preferred embodiments are explained by way of example with reference to the accompanying figures. They show:

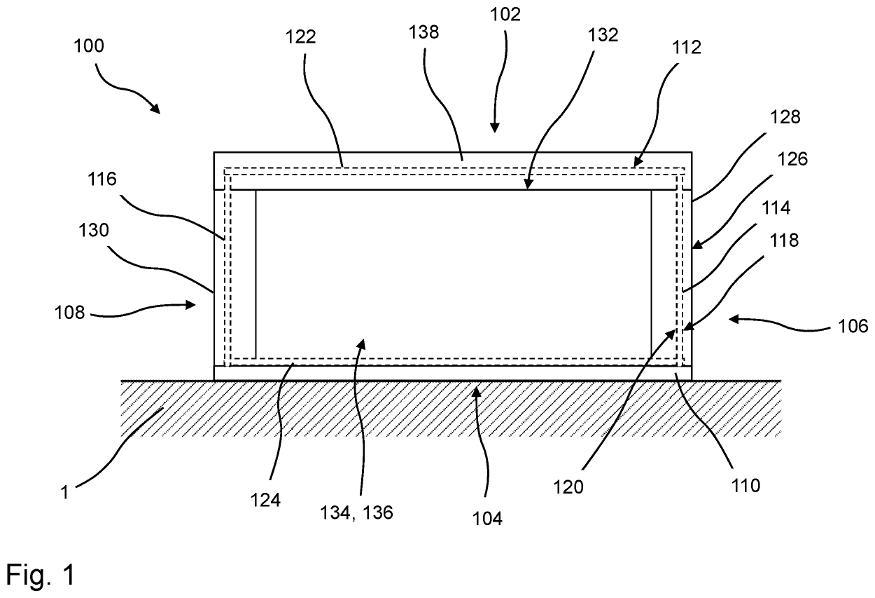

FIG. 1: a schematic, two-dimensional view of an exemplary embodiment of a structural concrete component;

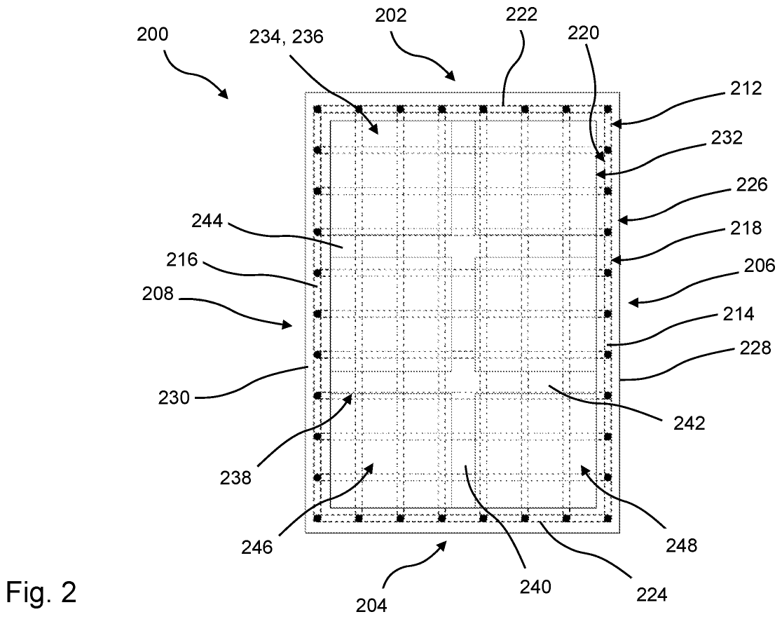

FIG. 2: a schematic, two-dimensional view of a further exemplary embodiment of a structural concrete component;

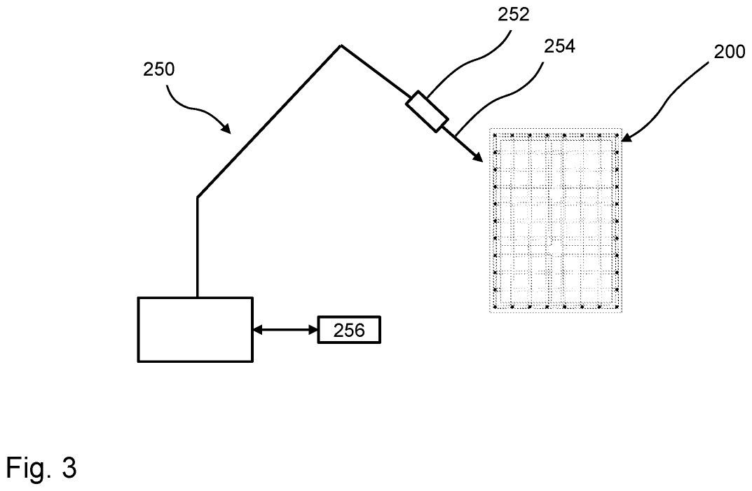

FIG. 3: a schematic, two-dimensional view of a further exemplary embodiment of a manufacturing system;

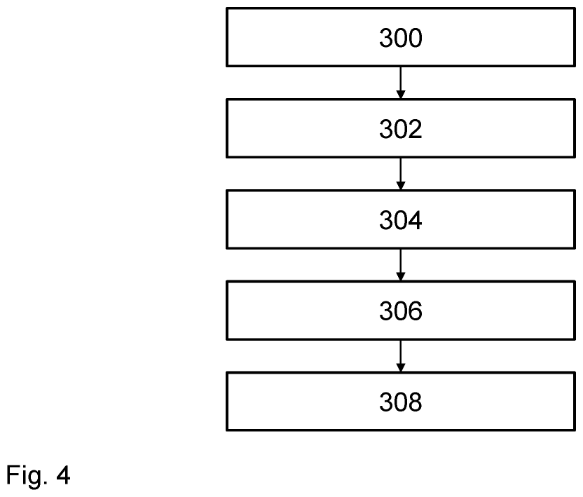

FIG. 4: a schematic representation of an exemplary embodiment of a method; and

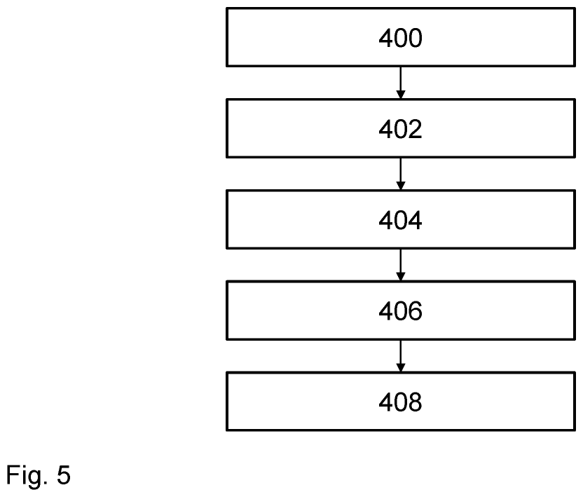

FIG. 5: a schematic representation of an exemplary embodiment of a further method.

In the figures, identical or substantially functionally identical or similar elements are designated by the same reference signs.

FIG. 1 shows a structural concrete component 100. The structural concrete component 100 is arranged on a steel pallet 1 on which the structural concrete component 100 has been produced. The structural concrete component 100 extends from a top end 102 to a bottom end 104, and from a first lateral end 106 to a second lateral end 108.

The structural concrete component 100 includes a base portion 110 configured as a concrete layer, which is preferably created first during producing. In addition, the structural concrete component 100 comprises a reinforcement unit 112. The reinforcement unit 112 is shown with dashed lines. The reinforcement unit 112 includes a first lateral reinforcement section 114 and a second lateral reinforcement section 116. The lateral reinforcement sections 114, 116 are connected to an upper reinforcement section 122 and a lower reinforcement section 124 and generate a reinforcement space 134 with other lateral reinforcement sections not shown. The lower reinforcement section 124 is adjacent to the base section 110. During producing, the reinforcement unit 112 was arranged with the lower reinforcement section 124 at the base section 110.

The reinforcement unit 112, and in particular the first lateral reinforcement section 114, includes a first outwardly facing side 118 and a second inwardly facing side 120.

The structural concrete component 100 further comprises a first structural component section 126 and a second structural component section 132, the first structural component section 126 having a first side wall 128 and a second side wall 130. It is preferred that the first structural component section 126 has two further side walls, not shown here, connecting the side walls 128, 130. The concrete of the first structural member section 126 has a first setting time during producing. This is caused by the concrete of the first component section 126 having a first accelerator portion. This accelerator proportion is relatively high, so that the side walls 128, 130 of the first component section 126 can be produced quickly and in a geometrically reliable manner.

A filling space 136 is configured through the first component section 126, and in particular through the first side wall 128 and the second side wall 130.

The filling space 136 extends from the first side wall 128 to the second side wall 130. The filling space 136 is filled with concrete, which concrete forms the second component section 132. The concrete of the second component section 132 has a second setting time that is greater than the first setting time. In particular, the concrete of the second component section 132 may have little or no accelerator means because rapid solidification of the second component section 132 is not required due to the shaping sidewalls 128, 130. Adjacent to the upper end 102, the structural concrete component 100 includes a cover layer 138. The top layer 138 has a third setting time, which is preferably greater than the first and/or second setting time.

FIG. 2 illustrates another embodiment of a structural concrete component 200. The structural concrete component 200 extends from a top end 202 to a bottom end 204 and from a first lateral end 206 to a second lateral end 208. The structural concrete component 200 further comprises a reinforcement unit 212 having a first lateral reinforcement section 214 and a second lateral reinforcement section 216.

Further, the reinforcement unit 212 includes an upper reinforcement section 222 and a lower reinforcement section 224 which form a reinforcement space 234 with the lateral reinforcement sections 214, 216. The first lateral reinforcement section 214 has an outwardly facing first side 218 and an inwardly facing second side 220.

The structural concrete component 200 includes a first structural component portion 226 forming a fill space 236. This filling space 236 extends in particular between the first side wall 228 and the second side wall 230, and preferably between two further side walls of the first component section 226 not shown here. A support structure 238 is arranged in the filling space 236. the support structure 238 comprises a vertical support element 240 and two horizontal support elements 242, A total of six support spaces 246, 248 are configured by the support elements 240, 242. The concrete of the second component section 232 is filled into the support spaces 246, 248 during producing. As a result, the hydrostatic pressure on the first component section 226, in particular on the first side wall 228 and the second side wall 230, is reduced.

FIG. 3 illustrates a manufacturing system 250 for producing the structural concrete component 100, 200. The manufacturing system 250 comprises an application unit 252 for producing the first structural component section 126, 226 and the second structural component section 132, 232 with concrete which comprises an accelerating agent. The concrete exits the application unit 252 with a concrete application direction 254 and impinges on the component 200 at an angle in the present case. Further, the manufacturing system 250 comprises a control device 256 which is arranged and configured to control a mixing of the concrete with the accelerating means such that a first setting time of the concrete of the first component section 126, 226 and a second setting time of the concrete of the second component section 132, 232 are different.

FIG. 4 illustrates a schematic method. In step 300, a base section 110 is created. In step 302, a reinforcement unit 112, 212 is arranged on the base section 110. At the time of arranging the reinforcement unit 112, 212, the concrete of the base section 110 has preferably already solidified and/or hardened.

In step 304, a first component section 126, 226 is created using a free-forming method. The first structural member section 126, 226 comprises or includes a concrete having a first setting time. The first setting time of this concrete is caused, for example, by a first accelerator portion.

In step 306, a second component section 132, 232 is produced by a free-forming method. The second component section 132, 232 comprises or includes a concrete having a second setting time, for example, effected by a second accelerator portion different from the first accelerator portion. In step 308, a top layer 138, 238 is produced.

FIG. 5 shows another schematic method. In step 400, a base section 110 is generated and a reinforcement unit 112, 212 is arranged thereon in step 402. In step 404, a first structural section 126, 226 is created using a free-forming method with a concrete having a first setting time.

In step 406, a support structure 238 is created within the fill space 236 and/or reinforcement space 234, particularly of concrete. The support structure 238 is arranged and configured to reduce a hydrostatic pressure on the first structural member portion 226. The support structure 238 is created such that it includes a plurality of support spaces 246, 248. Thereafter, or partially simultaneously, the second component section 232 is created in step 408. Here, among other things, concrete is arranged in the support spaces 246, 248.

The structural concrete component 100, 200 described in the foregoing and the method for producing such a structural concrete component 100, 200 are characterized by a plurality of advantages. This structural concrete component 100, 200 is of higher quality than known components, since only the smallest necessary amount of accelerator is always applied. Furthermore, the method of producing the structural concrete component 100, 200 is more productive, since a concrete which has a lower accelerator quantity has a lower concrete pressure. Further, the use of a reinforcement reduces or eliminates the creation of a splash shadow.

### REFERENCE SIGNS

1 steel pallet
100 structural concrete component
102 upper end
104 lower end
106 first lateral end
108 second lateral end
110 base section
112 reinforcement unit
114 first lateral reinforcement section
116 second lateral reinforcement section
118 first side
120 second side
122 upper reinforcement section
124 lower reinforcement section
126 first component section
128 first side wall
130 second side wall
132 second component section
134 reinforcement space
136 filling space
138 cover layer
200 structural concrete component
202 upper end
204 lower end
206 first lateral end
208 second lateral end
212 reinforcement unit
214 first lateral reinforcement section
216 second lateral reinforcement section
218 first side
220 second side
222 upper reinforcement section
224 lower reinforcement section
226 first structural section
228 first side wall
230 second side wall
232 second component section
234 reinforcement space
236 filling space
238 support structure
240 vertical support element
242 horizontal support element
244 horizontal support element
246 first support space
248 second support space
250 manufacturing system
252 application unit
254 concrete application direction
256 control device

1. A method of producing a structural concrete component, comprising the steps of:
Producing a first component section and a second component section with concrete,
wherein the first component section and the second component section are produced by a free-forming method, and
wherein the concrete is provided such that a first setting time of the concrete of the first component section and a second setting time of the second component section are different.

2. The method according to claim 1, wherein
the concrete is provided with an accelerator, and
the concrete for the first component section comprises a first accelerator portion and the concrete for the second component section comprises a second accelerator portion different from the first accelerator portion.

3. The method according to claim 1, wherein
the concrete for the first component section is provided with a first accelerator means and the concrete for the second component section is provided with a second accelerator means, and
the first accelerator means effects the first setting time and the second accelerator means effects the second setting time.

4. The method according to claim 1, wherein
the first component section is produced such that it laterally encloses a filling space,
the second component section is produced such that it fills the filling space,
the first component section is produced temporally before the second component section, and
the first setting time is shorter than the second setting time.

5. The method according to claim 1, comprising the step of:
Arranging a reinforcement unit, wherein the first component section is generated at least in sections on a first side of the reinforcement unit and the second component section is generated on a second side of the reinforcement unit opposite to the first side.

6. The method according to claim 1, wherein a reinforcement unit comprises lateral reinforcement sections which are vertically aligned during the producing of the structural concrete component, and form a reinforcement space, whereby
the first component section encloses the lateral reinforcement sections of the reinforcement unit,
the second component section is produced within the reinforcement space and at least partially fills the reinforcement space, and
the first setting time is shorter than the second setting time.

7. The method according to claim 1, comprising the step of:
Creating a support structure of concrete within a filling space and/or a reinforcement space, which is arranged and configured to reduce a hydrostatic pressure on the first component section,
wherein the support structure forms two or more support spaces for receiving concrete of the second component section.

8. The method according to claim 1, comprising the step of:
Producing a cover layer coupled to at least one of the first component section and the second component section, wherein the cover layer is produced with a concrete having a third setting time,
wherein the third setting time is greater than the first setting time and/or second setting time.

9. A production system for producing a concrete component and for carrying out the method according to claim 1, comprising
an application unit for producing the first component section and the second component section with concrete which comprises an accelerator means, and
a control device arranged and configured to control a mixing of the concrete with the accelerating means such that the first setting time of the concrete of the first component section and the second setting time of the concrete of the second component section are different.

10. A concrete structural member, comprising
a first component section, and
a second component section,
wherein concrete of the first component section has a first setting time and concrete of the second component section has a second setting time,
wherein the first setting time and the second setting time are different.

11. The concrete structural component according to claim 10, wherein
the concrete of the first component section has a first accelerator component and the concrete of the second component section has a second accelerator component different from the first accelerator component.

12. The concrete structural member according to claim 10, comprising
a reinforcement unit, wherein the first component section is arranged at least in sections on a first side of the reinforcement unit and the second component section is arranged on a second side of the reinforcement unit opposite the first side.

13. The concrete structural component according to claim 10, wherein
a reinforcement unit comprises lateral reinforcement sections which are vertically aligned when producing the concrete structural component, and form a reinforcement space,
the first component section encloses the lateral reinforcement sections of the reinforcement unit,
the second component section is arranged within the reinforcement space and at least partially fills the reinforcement space, and
the first setting time is shorter than the second setting time.

14. The concrete structural component according to claim 10, wherein
the first component section laterally encloses a filling space (136),
the second component section fills the filling space, and
the first setting time is less than the second setting time.

15. The concrete structural component according to claim 10, comprising
a support structure comprising concrete within a filling space, arranged and configured to reduce a hydrostatic pressure on the first component section,
wherein the support structure comprises two or more support spaces within which concrete of the second component section is arranged.

16. The concrete structural component according to claim 10, comprising
a cover layer coupled to at least one of the first component section and the second component section, wherein the cover layer comprises or consists of a concrete having a third setting time,
wherein the third setting time is greater than the first setting time and/or second setting time.
